(19) United States
(12) Patent Application Publication
(10) Pub. No.: US 2026/0184035 A1
(43) Pub. Date: Jul. 2, 2026

(54) DETECTION DEVICE, SHEET POSITION ADJUSTMENT DEVICE, AND CORRUGATE MACHINE

(71) Applicant: MITSUBISHI HEAVY INDUSTRIES MACHINERY SYSTEMS, LTD., Kobe-shi, Hyogo (JP)

(72) Inventors: Hideki MIZUTANI, Kobe-shi, Hyogo (JP); Koki SAKAMOTO, Kobe-shi, Hyogo (JP)

(21) Appl. No.: 18/728,454

(22) PCT Filed: Dec. 23, 2022
(86) PCT No.: PCT/JP2022/047773

§ 371 Date: Jul. 12, 2024

(30) Foreign Application Priority Data
Jan. 31, 2022 (JP) 2022-012752

(51) Int. Cl. B31F 1/28

(52) U.S. Cl. CPC B31F 1/2836; B31F 1/284

(57) ABSTRACT

A detection device for detecting, during conveyance of a strip-shaped corrugated cardboard sheet, a position at an end in a width direction of the corrugated board sheet includes: a measurement device measuring, in a measurement range including a prescribed measurement reference point and one end in the width direction of the corrugated board sheet, positions of measurement points on a straight line in the width direction; and a specifying device specifying, based on the measured measurement points, a true end position in the width direction in a state where the corrugated board sheet is not warped. The specifying device calculates each of distances between adjacent measurement points, adds up all the distances to calculate a sheet width length from the measurement reference point to the end, and specifies a position separated by the sheet width length in the width direction from the measurement reference point as a true end position.

### TECHNICAL FIELD

The present application relates to a detection device that detects a position of an edge of a corrugated cardboard sheet in a width direction, a sheet position adjustment device for a corrugated cardboard sheet, and a corrugating machine.

### BACKGROUND ART

The corrugating machine is a device that manufactures a corrugated cardboard for box manufacture, which is an end product, by performing processing such as forming a creasing line, trimming, and cutting while transporting a band-shaped corrugated cardboard sheet obtained by bonding liners and a medium to each other. In this corrugating machine, an edge position of the corrugated cardboard sheet in a width direction is measured so that the corrugated cardboard sheet is appropriately transported.

Meanwhile, the corrugated cardboard sheet during transportation may be warped in the width direction. In a case where a warp is formed as above, a position, which is offset from an original (true) edge position to be closer to the center in the width direction than the original edge position is, detected as the edge position of the corrugated cardboard sheet and the true edge position cannot be measured accurately if the edge position of the corrugated cardboard sheet is measured without consideration of the warp. In addition, the corrugated cardboard sheet during transportation may shake in a vertical direction (so-called “rattling” may occur) and thus a portion of the corrugated cardboard sheet may be temporarily deformed upward or downward in comparison with another portion of the corrugated cardboard sheet. In a case where the edge position of the corrugated cardboard sheet is measured in a state where such rattling occurs, a position, which is offset from an original (true) edge position to be closer to the center in the width direction than the original edge position is, is detected as the edge position of the corrugated cardboard sheet and the true edge position cannot be measured accurately as in the case of a state where the corrugated cardboard sheet is warped.

As a technique for performing accurate measurement with respect to a warp in a width direction, disclosed in PTL 1 is a technique for measuring a true plate width relating to a case where a plate material is flattened such that there is no warp.

### CITATION LIST

### Patent Literature

[PTL 1] Japanese Unexamined Patent Application Publication No. 63-184002

### SUMMARY OF INVENTION

### Technical Problem

However, in the case of the technique of PTL 1 described above, the true plate width can be measured but a true edge position in a state where there is no warp cannot be detected.

Therefore, if the technique of PTL 1 is simply applied to a corrugating machine, there is a possibility that a corrugated cardboard sheet cannot be appropriately processed and the corrugated cardboard sheet cannot be appropriately transported, for example.

The present application has been devised in consideration of the above-described problem, and an object thereof is to enable detection of a true edge position in a width direction in a state where a corrugated cardboard sheet is not warped. Note that the object of the present application is not limited thereto, and another object of the present application is to exhibit actions and effects that are derived from each configuration disclosed in “Description of Embodiments” to be described later but cannot be obtained by a technique in the related art.

### Solution to Problem

(1) The present application provides a detection device that detects a position of an edge of a band-shaped corrugated cardboard sheet in a width direction while the corrugated cardboard sheet is being transported. The detection device includes: measurement means for measuring, within a measurement range including a predetermined measurement reference point of the corrugated cardboard sheet in the width direction and the edge on at least one side in the width direction, positions of a plurality of measurement points in a linear shape in the width direction; and specifying means for specifying, based on the plurality of measurement points measured by the measurement means, a true edge position in the width direction in a state where the corrugated cardboard sheet is not warped. The specifying means calculates each of distances between the measurement points adjacent to each other, adds up all the distances to calculate a sheet width length from the measurement reference point to the edge, and specifies, as the true edge position, a position that is separated from the measurement reference point in the width direction by the sheet width length.

(2) The present application provides a sheet position adjustment device including: the above-described detection device; calculation means for calculating, based on the true edge position specified by the detection device and a reference position at a time of transportation of a band-shaped corrugated cardboard sheet, an offset amount of a position of the corrugated cardboard sheet in a width direction; and correction means for correcting, based on the offset amount calculated by the calculation means, the position of the corrugated cardboard sheet in the width direction.

(3) The present application provides a corrugating machine including the above-described sheet position adjustment device.

### Advantageous Effects of Invention

Even in a case where a corrugated cardboard sheet is warped, a true edge position of the corrugated cardboard sheet in a width direction can be detected.

### BRIEF DESCRIPTION OF DRAWINGS

FIG. 1 is an explanatory view of a detection device and a sheet position adjustment device according to one embodiment of the present application.

FIG. 2 is an explanatory view of a corrugating machine including the detection device and the sheet position adjustment device in FIG. 1.

FIG. 3 is a view for description of the detection ranges of sensors of the detection device in FIG. 1, and is a view as seen in a direction toward a downstream side in a transport direction.

FIG. 4 is an explanatory view relating to detection of a true edge position of a single-faced web in the detection device in FIG. 1.

FIG. 5 is an explanatory view in which a range including a second measurement reference point and the other edge of the single-faced web in FIG. 4 is enlarged.

FIGS. 6A to 6C are explanatory views relating to position adjustment in a width direction performed in a case where a central position of a bottom liner in the width direction is a reference position.

FIGS. 7A and 7B are explanatory views relating to inclination control of an axis of a meandering correction roll.

FIGS. 8A to 8C are explanatory views relating to position adjustment in the width direction performed in a case where an edge position of the bottom liner in the width direction is a reference position.

FIGS. 9A to 9C are explanatory views (views corresponding to FIG. 4) according to modification examples.

FIG. 10 is an explanatory view (a view corresponding to FIG. 4) according to another modification example.

FIG. 11 is an explanatory view of a detection device and a sheet position adjustment device for a single-wall corrugated cardboard.

### DESCRIPTION OF EMBODIMENTS

A detection device, a sheet position adjustment device, and a corrugating machine as an embodiment will be described with reference to the drawings. The following embodiment is provided as merely an example, and is not intended to exclude the application of various modifications or techniques that are not specified in the following embodiment. Each configuration of the present embodiment can be modified and implemented in various forms without departing from the concept of the present embodiment. In addition, the configurations can be optionally selected when necessary, or can be appropriately combined with each other.

### [1. Configuration of Device]

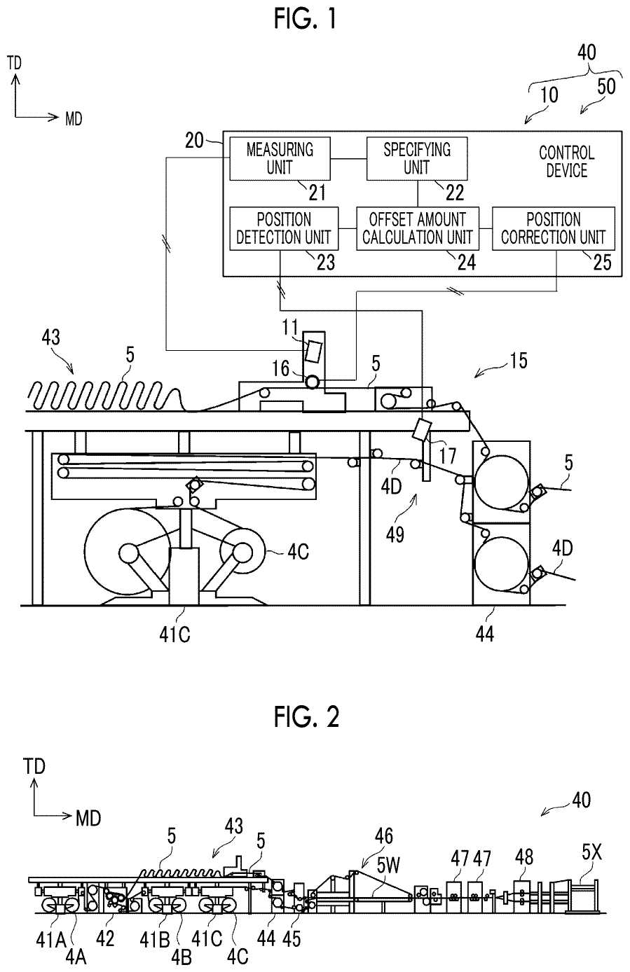

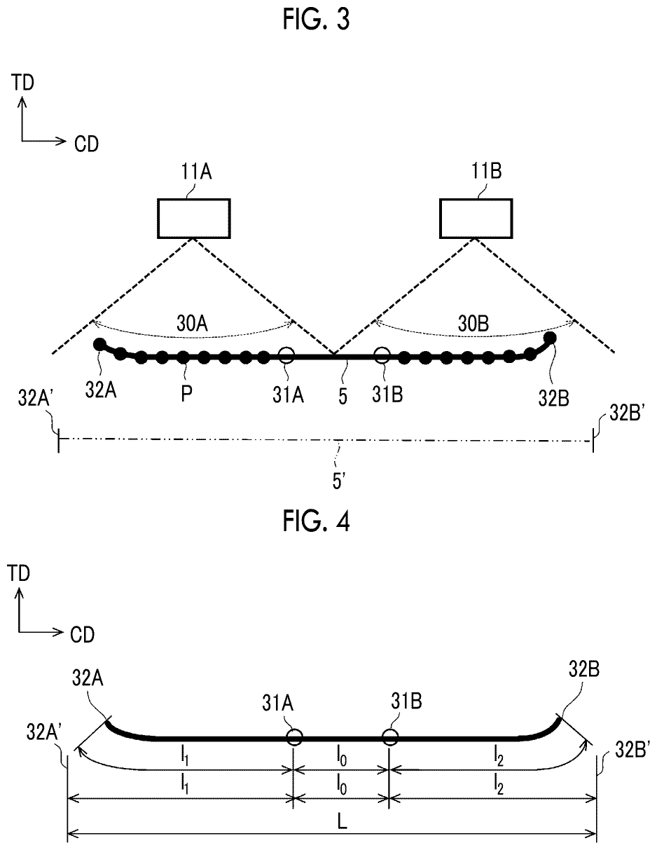

FIG. 1 is an explanatory view of a detection device and a sheet position adjustment device according to the present embodiment. A corrugating machine is equipped with the detection device and the sheet position adjustment device of FIG. 1. First, the configuration of the corrugating machine including the detection device and the sheet position adjustment device will be roughly described with reference to FIGS. 2 and 3.

In the present specification, a transport direction (MD in FIG. 2) is a direction in which a corrugated cardboard is transported in the corrugating machine. The transport direction corresponds to a longitudinal direction in which a band-shaped corrugated cardboard sheet extends. A width direction of the corrugated cardboard sheet (hereinafter, may be simply referred to as “width direction”) corresponds to a machine width direction (CD in FIG. 3) of the corrugating machine. A direction orthogonal to both the longitudinal direction and the width direction will be referred to as a “height direction”. The height direction corresponds to a vertical direction (TD in FIGS. 2 and 3) in the corrugating machine.

FIG. 2 shows a corrugating machine 40 and the corrugating machine 40 is a corrugated cardboard manufacturing device that manufactures a single-wall corrugated cardboard by bonding a bottom liner and a top liner onto both surfaces of a medium and that manufactures a corrugated cardboard for box manufacture, which is an end product, by performing processing such as forming a creasing line, trimming, and cutting with respect to the single-wall corrugated cardboard. Band-shaped paper rolls (liner sheets) 4A, 4B, and 4C used for the bottom liner, the medium, and the top liner are supplied to the corrugating machine 40 from mill roll stands 41A, 41B, and 41C.

The mill roll stands 41A, 41B, and 41C are disposed adjacent to each other in this order from an upstream side to a downstream side in the transport direction MD.

A single facer 42 is provided downstream of the mill roll stand 41A and upstream of the mill roll stand 41B while being adjacent to the mill roll stands 41A and 41B. To the single facer 42, the paper roll 4A for the top liner is supplied from the mill roll stand 41A, and the paper roll 4B for the medium is supplied from the mill roll stand 41B.

The single facer 42 forms a band-shaped single-faced web 5 by corrugating the paper roll 4B for the medium to process the paper roll 4B into a wave-like shape and bonding the paper roll 4A for the top liner onto flute tips of the paper roll 4B for the medium which has been processed into the wave-like shape.

The single-faced web 5 is a corrugated cardboard sheet obtained by bonding the top liner to one surface of the medium.

A bridge 43 is disposed downstream of the single facer 42 and above the mill roll stands 41B and 41C.

A double facer 46 is provided downstream of the mill roll stand 41C and the bridge 43 with a preheater 44 and a glue machine 45 interposed therebetween.

The bridge 43 is a bridge-shaped transport path for transporting, to the double facer 46, the single-faced web 5 formed by the single facer 42. The bridge 43 functions as a retaining unit that temporarily retains the single-faced web 5 to absorb a speed difference between the single facer 42 and the double facer 46.

The preheater 44 heats each of the single-faced web 5 transported from the bridge 43 and the paper roll 4C for the bottom liner which is supplied from the mill roll stand 41C. The glue machine 45 applies an adhesive to flute tips of a surface of the single-faced web 5 that is opposite to a surface onto which the top liner is bonded.

The double facer 46 forms a single-wall corrugated cardboard 5W by bonding the paper roll 4C for the bottom liner to the single-faced web 5 and transports the formed single-wall corrugated cardboard 5W to the downstream side. The single-wall corrugated cardboard 5W is a corrugated cardboard sheet obtained by bonding the liners to both surfaces of the medium.

A slitter scorer 47 and a cutoff 48 are disposed downstream of the double facer 46 in this order to be adjacent to each other in the transport direction MD. Each of the slitter scorer 47 and the cutoff 48 performs processing such as forming a creasing line, trimming, and cutting with respect to the single-wall corrugated cardboard 5W during transportation while transporting the single-wall corrugated cardboard 5W.

In this manner, a corrugated cardboard 5X for box manufacture, which is an end product, is manufactured. The operation of the corrugating machine 40 is automatically controlled by a production management device (not shown).

Next, the configurations of a detection device 10 and a sheet position adjustment device 50 provided in the corrugating machine 40 will be described.

The detection device 10 is a device that detects an edge position of a corrugated cardboard sheet in a width direction during transportation and is provided to specify the position (will be referred to as “true edge position) of an edge of an ideal corrugated cardboard sheet in the width direction, the ideal corrugated cardboard sheet being a corrugated cardboard sheet that is not warped. The expression “to be warped” means that a portion of a corrugated cardboard sheet is deformed upward or downward in comparison with another portion of the corrugated cardboard sheet. Although the corrugated cardboard sheet can be warped in a planar manner, since the edge position is detected by the detection device 10 of which the position is fixed with respect to the corrugated cardboard sheet during transportation (that is, moving), a warp of the corrugated cardboard sheet is detected as a warp in the width direction of the corrugated cardboard sheet. However, the “warp” detected herein also means displacement occurring as a result of a phenomenon in which the corrugated cardboard sheet during transportation shakes in a vertical direction (occurrence of so-called “rattling”) and thus a portion of the corrugated cardboard sheet is temporarily deformed upward or downward in comparison with another portion of the corrugated cardboard sheet.

The sheet position adjustment device 50 is a device that adjusts the position of the corrugated cardboard sheet in the width direction and particularly in the present embodiment, the sheet position adjustment device 50 adjusts the position of the corrugated cardboard sheet in the width direction during transportation by using the true edge position specified by the detection device 10 so that the corrugated cardboard sheet is transported while being at an appropriate position in the width direction.

The configuration of the detection device 10 will be described first and then the configuration of the sheet position adjustment device 50 will be described. Note that since the corrugated cardboard sheet to be a target of detection and transportation at the detection device 10 and the sheet position adjustment device 50 is not limited to the single-faced web 5, the corrugated cardboard sheet may also be referred to as a “corrugated cardboard sheet 5” in the following description.

As shown in FIG. 1, the detection device 10 of the present embodiment is annexed to a transport path 15 of the corrugated cardboard sheet 5 in the corrugating machine 40. The transport path 15 forms a path through which the corrugated cardboard sheet 5 is transported from the bridge 43 to the preheater 44 and is provided above a transport path 49 to be parallel with the transport path 49, the transport path 49 being a path through which the paper roll 4C for the bottom liner is transported from the mill roll stand 41C to the preheater 44. The transport path 15 is configured to include a plurality of transport rolls.

The detection device 10 includes sensors 11 (measurement means), which are disposed, for example, to be separated from the corrugated cardboard sheet 5 during transportation while above the corrugated cardboard sheet 5, and a control device 20.

Each sensor 11 is a detector for detecting an edge position of the corrugated cardboard sheet 5 in the width direction during transportation through the transport path 15 and the sensor 11 outputs, as a detection signal, position information including the position of the corrugated cardboard sheet 5 in the width direction and the position of the corrugated cardboard sheet 5 in the height direction.

Specific examples of the sensors 11 of the present embodiment include a two-dimensional profile sensor. The two-dimensional profile sensor is a laser displacement sensor that irradiates an upper surface of the corrugated cardboard sheet 5 with a laser beam and that outputs a detection signal based on reflected light.

FIG. 3 is a view for description of the detection ranges of the sensors 11, and is a view as seen in a direction toward the downstream side in the transport direction. A thick line in the drawing is a cross-sectional view of the corrugated cardboard sheet 5 cut along the width direction. Note that in FIG. 3, the transport path 15 and the corrugating machine 40 are not shown.

As shown in FIG. 3, a plurality of the sensors 11 of the present embodiment are provided in the width direction. Specifically, the sensors 11 include two sensors 11A and 11B (first measurement means and second measurement means). The sensors 11A and 11B are disposed to be adjacent to each other in the width direction of the transport path 15. The first sensor 11A is provided to specify an edge 32A (hereinafter, will be referred to as “one edge 32A”) of the corrugated cardboard sheet 5 that is on one side in the width direction. The second sensor 11B is disposed on the other side in the width direction to be adjacent to the first sensor 11A and is provided to specify an edge 32B (hereinafter, will be referred to as “the other edge 32B”) of the corrugated cardboard sheet 5 that is on the other side in the width direction. The two sensors 11A and 11B are the same as each other and only the places where the two sensors 11A and 11B are disposed and the measurement ranges thereof are different from each other, the measurement ranges thereof being different from each other because the places where the two sensors 11A and 11B are disposed are different from each other. In the following description, the two sensors 11A and 11B will be collectively referred to as the sensor 11 in a case where the sensors 11A and 11B are not to be distinguished from each other.

As shown in FIG. 1, the sensor 11 is connected to an input side of the control device 20 and a detection signal of the sensor 11 is input to the control device 20.

The control device 20 is, for example, an electronic control device configured as an LSI device or a built-in electronic device in which a microprocessor, a ROM, a RAM, or the like is integrated. In the control device 20, a measuring unit 21 (measurement means) and a specifying unit 22 (specifying means) are provided as functional elements relating to the detection device 10. These elements 21 and 22 represent a part of the functions of a program executed by the control device 20 and may be realized by software and a part or all of the functions may be realized by hardware (an electronic circuit) or may be realized by a combination of software and hardware.

As shown in FIG. 1, the sheet position adjustment device 50 of the present embodiment is configured to include the detection device 10 and a meandering correction roll 16 (correction means).

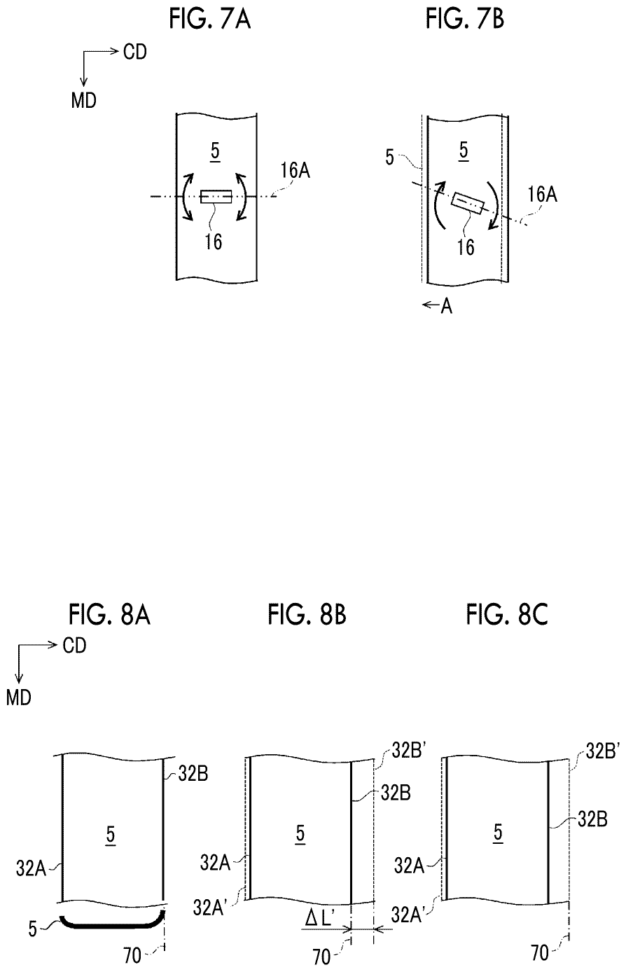

The meandering correction roll 16 is provided to adjust the position of the corrugated cardboard sheet 5 in the width direction during transportation and is composed of a cylindrical rotating body of which an axis 16A (refer to FIG. 7A) extends in the width direction.

The meandering correction roll 16 is disposed at a height at which an outer peripheral surface thereof comes into contact with an upper surface of the corrugated cardboard sheet 5 and is rotated around the axis 16A while being in contact with the upper surface of the corrugated cardboard sheet 5 during transportation of the corrugated cardboard sheet 5.

The meandering correction roll 16 is supported such that the inclination of the axis 16A with respect to the width direction can be changed and the position of the corrugated cardboard sheet 5 during transportation can be finely adjusted, corresponding to the inclination of the axis 16A, in the width direction from one side to the other side in the width direction or from the other side to the one side. Note that an actuator (not shown) that changes the inclination of the axis 16A of the meandering correction roll 16 is provided.

The actuator of the meandering correction roll 16 is connected to an output side of the control device 20 and the inclination of the axis 16A of the meandering correction roll 16 is changed in a case where the actuator is controlled by the control device 20.

In the sheet position adjustment device 50, the position of the corrugated cardboard sheet 5 in the width direction is adjusted during transportation to match a reference position at the time of transportation of the corrugated cardboard sheet 5 through the transport path 15. The “reference position” referred to herein is a position in the width direction that serves as a reference when the corrugated cardboard sheet 5 is transported through the transport path 15.

In the present embodiment, a case where a central position, in the width direction, on a portion (hereinafter, this portion will be referred to as a “bottom liner 4D”) of the paper roll 4C for a bottom liner immediately before the bonding of the paper roll 4C to the single-faced web 5 is used as the reference position will be described as an example.

A camera 17 provided above the transport path 49 is a detector for detecting the central position of the bottom liner 4D in the width direction while the bottom liner 4D is being transported through the transport path 49. An upper surface of the bottom liner 4D during transportation through the transport path 49 is imaged by the camera 17.

The camera 17 is connected to an input side of the control device 20, and data of an image captured by the camera 17 is input to the control device 20.

The sheet position adjustment device 50 of the present embodiment further includes a position detection unit 23, an offset amount calculation unit 24 (calculation means), and a position correction unit 25 (correction means) which are provided in the control device 20 as functional elements relating to a function of performing position adjustment in the width direction in the sheet position adjustment device 50. As with the above-described elements 21 and 22, these elements 23, 24, and 25 also represent a part of the functions of a program executed by the control device 20 and may be realized by software, hardware (an electronic circuit), or a combination thereof.

### [2. Control Configuration]

Next, each of the units 21 to 25 provided as a functional element in the control device 20 will be described.

First, the measuring unit 21 and the specifying unit 22 provided as functional elements relating to the detection device 10 will be described.

The measuring unit 21 measures, based on an output signal of the sensor 11, the positions of a plurality of measurement points in a linear shape in the width direction in a predetermined measurement range in the width direction of the corrugated cardboard sheet 5. The measurement range is a range including a predetermined measurement reference point (which will be described later) in the width direction of the corrugated cardboard sheet 5 and at least one edge in the width direction. This measurement range is determined in advance based on the performance or disposition of the sensor 11.

The positions of the plurality of measurement points measured by the sensor 11 and the measuring unit 21 are position information represented by XY coordinates with the measurement reference point as the origin, the width direction of the corrugated cardboard sheet 5 as the X-axis, and the height direction as the Y-axis. The XY coordinates are two-dimensional coordinates of which the X coordinate represents a position separated from the measurement reference point in the width direction and the Y coordinate represents a position separated from the measurement reference point in the height direction.

Each of measurement ranges 30A and 30B will be specifically described while using the two sensors 11A and 11B as an example as shown in FIG. 3. Broken lines in the drawing represent the measurement ranges 30A and 30B, and the thick line in the drawing represents a cross section of the corrugated cardboard sheet 5 during transportation which is cut along the width direction. Black solid circles overlapping with the thick line are measurement points P and outlined circles overlapping with the thick line are measurement reference points 31A and 31B. In addition, a two-dot chain line in the drawing is an ideal corrugated cardboard sheet 5′ with no warp.

In FIG. 3, the measurement range 30A of the first sensor 11A is a range including the first measurement reference point 31A and the one edge 32A in the width direction. The measurement range 30B of the second sensor 11B is a range including the second measurement reference point 31B and the other edge 32B in the width direction. Each of the sensors 11A and 11B is disposed such that the measurement reference points 31A and 31B and the edges 32A and 32B in the width direction are included in ranges of irradiation with laser beam (the measurement ranges 30A and 30B represented by the broken lines in the drawing).

In each of the measurement ranges 30A and 30B, a plurality of the measurement points P are set on a plane in the width direction. Specifically, the plurality of measurement points P are linearly disposed in the width direction in a plan view as seen from the sensors 11A and 11B. More specifically, the plurality of measurement points P are disposed in a linear shape in the width direction orthogonal to the transport direction of the corrugated cardboard sheet 5 in a plan view as seen from the sensors 11A and 11B. The number of the measurement points P in each of the measurement ranges 30A and 30B may be appropriately set in accordance with the specifications (performance, disposition, or the like) of the sensors 11A and 11B or the processing performance of the control device 20 and is not particularly limited. From the viewpoint of improving measurement accuracy, it is preferable that the number of the measurement points P is large. On the contrary, from the viewpoint of reducing the control load, it is preferable that the number of the measurement points P is not so large, and the number of the measurement points P is appropriately set in consideration of these points. Note that in a case where the two sensors 11A and 11B are provided, the numbers of the measurement points P in the two measurement ranges 30A and 30B are made equal to each other. However, the numbers of the measurement points P in the two measurement ranges 30A and 30B may not be equal to each other.

The measurement reference points 31A and 31B are points (positions) that are used as references when measuring edge positions of a corrugated cardboard sheet in the width direction and are determined as any positions in a machine width direction of the transport path 15 in advance. The number of the measurement reference points 31 is not particularly limited and may be equal to or greater than the number of the sensors 11 or may be smaller than the number of the sensors 11. In the present embodiment, the same number of measurement reference points 31 as the number of the sensors 11 are set, that is, one measurement reference point 31 is set for one sensor 11. It is preferable that the measurement reference points 31A and 31B are set in the vicinity of the center in the width direction of the corrugated cardboard sheet 5 from the viewpoint of making the corrugated cardboard sheet 5 less likely to be warped and stabilizing the position of the corrugated cardboard sheet 5. In an example shown in FIG. 3, the first measurement reference point 31A and the second measurement reference point 31B are set to be adjacent to each other in the vicinity of the center in the width direction of the corrugated cardboard sheet 5.

The actual positions of the edges 32A and 32B of the corrugated cardboard sheet 5 can be specified, based on an output signal of the sensor 11, by the measuring unit 21 with a well-known technique. In the case of the corrugated cardboard sheet 5 of which regions including both edges 32A and 32B in the width direction are warped as shown in FIG. 3, both edges 32A and 32B are specified at positions that are offset from the positions of both edges 32A′ and 32B′ of the ideal corrugated cardboard sheet 5′, which is not warped as represented by the two-dot chain line in the drawing, to be closer to the center in the width direction than the positions of both edges 32A′ and 32B′ are.

The measuring unit 21 expresses the position of each measurement point P by means of XY coordinates for each of the measurement ranges 30A and 30B, and outputs, to the specifying unit 22, the XY coordinates representing the position of each measurement point P.

The specifying unit 22 specifies a true edge position in the width direction in a state where there is no warp, based on the XY coordinates indicating the position of each of the measurement points P measured by the measuring unit 21. Note that the specifying unit 22 specifies the true edge position regardless of whether or not the corrugated cardboard sheet 5 is warped. In a case where an edge position of the corrugated cardboard sheet 5 with no warp is specified, the actual edge position and the true edge position coincide with each other.

The true edge position specified by the specifying unit 22 is transmitted to the offset amount calculation unit 24 and is used to adjust the position of the corrugated cardboard sheet 5 in the width direction.

The specifying unit 22 has the following configurations A to C in order to specify the true edge position.

Configuration A: Distances between the measurement points P adjacent to each other in the width direction are calculated based on the XY coordinates indicating the positions of the measurement points P.

Configuration B: A sheet width length from measurement reference point to an edge is calculated by adding up the distances between all the measurement points P adjacent to each other.

Configuration C: A position that is separated from the measurement reference point by the sheet width length in the width direction is specified as the true edge position.

FIG. 4 is an explanatory view showing true edge positions based on the detection signals of the sensors 11A and 11B of FIG. 3.

The specifying unit 22 calculates distances between the measurement points P adjacent to each other in the measurement range 30A and adds up all the distances to calculate a first sheet width length l₁ from the first measurement reference point 31A to the one edge 32A in the width direction. The first sheet width length l₁ can be regarded as a sheet width length from the first measurement reference point 31A to one edge 32A′ of the ideal corrugated cardboard sheet 5′. Therefore, the specifying unit 22 specifies, as the true edge position on one side in the width direction, a position that is linearly separated from the first measurement reference point 31A by the first sheet width length l₁ while being on the one edge 32A side in the width direction.

Similarly, the specifying unit 22 calculates distances between the measurement points P adjacent to each other in the measurement range 30B and adds up all the distances to calculate a second sheet width length 12 from the second measurement reference point 31B to the other edge 32B in the width direction. The second sheet width length 12 can be regarded as a sheet width length from the second measurement reference point 31B to the other edge 32B′ of the ideal corrugated cardboard sheet 5′. Therefore, the specifying unit 22 specifies, as the true edge position on the other side in the width direction, a position that is linearly separated from the second measurement reference point 31B by the second sheet width length 12 while being on the other edge 32B side in the width direction.

A specific example of an arithmetic equation used to calculate a sheet width length in the specifying unit 22 will be described. Although a case where the second sheet width length 12 is calculated will be used as an example here, the first sheet width length l₁ also can be calculated in the same manner.

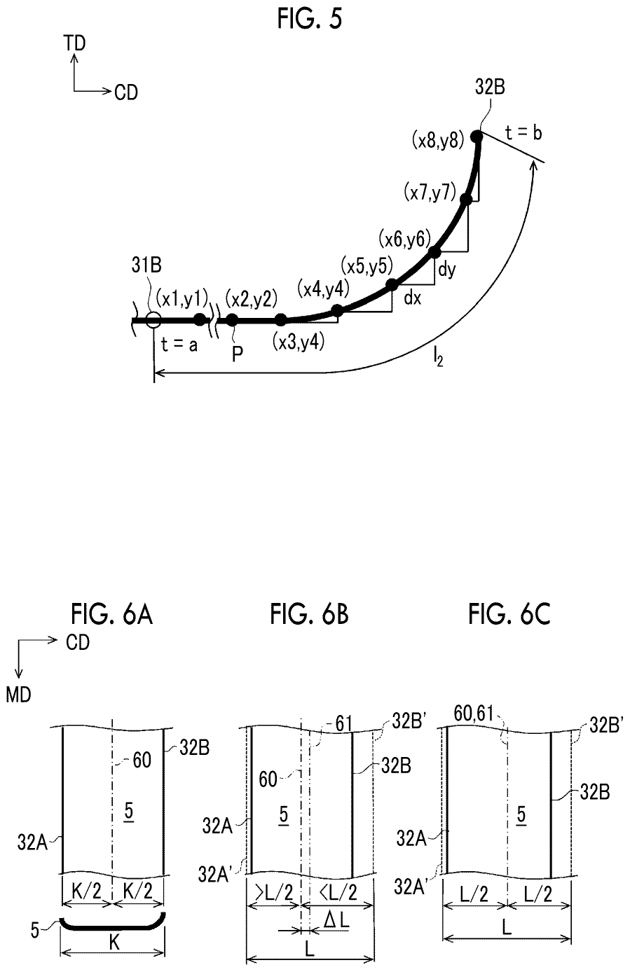

FIG. 5 is an explanatory view in which a range including the second measurement reference point 31B and the other edge 32B of the corrugated cardboard sheet 5 of FIG. 4 is enlarged. In the drawing, “(x1, y1)”, “(x2, y2)”, . . . , “(x8, y8)” are XY coordinates of the measurement points P (black solid circles of which only one is given a reference numeral), “dx” is a distance between X coordinates of the measurement points P adjacent to each other, and “dy” is a distance between Y coordinates of the measurement points P adjacent to each other.

As shown in FIG. 5, assuming that the second measurement reference point 31B is a parameter t=a and the other edge 32B is t=b, the second sheet width length 12 can be calculated via Equation 1 as follows.

$$[ Equation 1 ]$$

$${l}_{2} = {\int }_{a}^{b} \sqrt{{( dx )}^{2} + {( dy )}^{2}} dt \qquad Equation 1$$

In this case, the second sheet width length 12 is a value obtained by calculating linear distances between the measurement points P adjacent to each other and adding up all the linear distances.

In addition, since each of the measurement reference points 31A and 31B is determined in advance as any position in the machine width direction of the transport path 15, the specifying unit 22 can specify a central sheet width length l₀ between the two measurement reference points 31A and 31B.

The specifying unit 22 can calculate a total sheet width length L of the ideal corrugated cardboard sheet 5′ by adding up the central sheet width length l₀, the first sheet width length l₁, and the second sheet width length l₂.

Next, the position detection unit 23, the offset amount calculation unit 24, and the position correction unit 25 provided as functional elements relating to the sheet position adjustment device 50 will be described.

The position detection unit 23 specifies a central position of the bottom liner 4D in the width direction based on data of an image captured by the camera 17 and transmits the specified central position to the offset amount calculation unit 24 as a reference position.

The offset amount calculation u unit 24 calculates, based on true edge positions specified by the specifying unit 22 of the detection device 10 and the reference position transmitted from the position detection unit 23, an offset amount by which the position of the corrugated cardboard sheet 5 in the width direction is offset in the transport path 15.

The offset amount is a value (a length in the width direction) indicating a degree to which the corrugated cardboard sheet 5 in the transport path 15 is offset in the width direction from a position at which the corrugated cardboard sheet 5 is supposed to be transported. The offset amount calculation unit 24 transmits the calculated offset amount to the position correction unit 25.

In the offset amount calculation unit 24 of the present embodiment, the central position of the bottom liner 4D in the width direction is used as the reference position. In this case, the offset amount calculation unit 24 specifies an imaginary central position based on the true edge positions and compares the specified imaginary central position and the reference position to calculate the above-described offset amount.

The imaginary central position is a position in the width direction of the corrugated cardboard sheet 5 during transportation and is a central position between true edge positions on both sides in the width direction.

The position correction unit 25 adjusts the position of the corrugated cardboard sheet 5 in the transport path 15 in the width direction based on the offset amount calculated by the offset amount calculation unit 24. Since the sheet position adjustment device 50 of the present embodiment is provided with the meandering correction roll 16, the position correction unit 25 outputs a control signal based on the offset amount to the actuator of the meandering correction roll 16 so as to change the inclination of the axis 16A of the meandering correction roll 16.

FIGS. 6A to 6C are explanatory views relating to position adjustment in the width direction performed in a case where the central position of the bottom liner 4D in the width direction is a reference position 60 and are views showing the corrugated cardboard sheet 5 in a plan view. Note that only in FIG. 6A, a cross-sectional view along the width direction is added to show the corrugated cardboard sheet 5 being warped. One-dot chain lines in the drawings are lines obtained by extending the reference position 60 in the transport direction MD for the sake of convenience of description. In the case of the actual sheet position adjustment device 50, the reference position 60 differs depending on a position in the longitudinal direction of the corrugated cardboard sheet 5 since the corrugated cardboard sheet 5 is being transported.

The corrugated cardboard sheet 5 shown in FIGS. 6A to 6C is warped at regions including both edges 32A and 32B in the width direction. More specifically, as represented by a thick solid line in FIG. 6A, the corrugated cardboard sheet 5 is more significantly warped at a region including the other edge 32B in the width direction than at a region including the one edge 32A in the width direction.

FIG. 6A shows a state where a central position between the both edges 32A and 32B in the width direction is aligned with the reference position 60 represented by the one-dot chain line. A reference numeral “K” in the drawing is a dimension line representing a distance between both edges 32A and 32B in the width direction. The reference position 60 is aligned with a position that is separated from each of both edges 32A and 32B by “K/2” to be on the central side in the width direction. The above-described detection device 10 specifies true edge positions 32A′ and 32B′ of the edges 32A and 32B of the corrugated cardboard sheet 5 shown in FIG. 6A.

Broken lines in FIG. 6B are lines obtained by extending the specified true edge positions 32A′ and 32B′ in the transport direction MD and a two-dot chain line in FIG. 6B is a line obtained by extending an imaginary central position 61 in the transport direction MD, the imaginary central position 61 being obtained from the true edge positions 32A′ and 32B′. A reference numeral “L” in the drawing is a dimension line representing a distance between the true edge positions 32A′ and 32B′ in the width direction. The distance L can be regarded as the sheet width length of the ideal corrugated cardboard sheet 5′.

As described above, in a state where there is a warp, the positions of both edges 32A and 32B are specified as positions that are offset from the true edge positions 32A′ and 32B′ to be closer to the center in the width direction than the true edge positions 32A′ and 32B′ are. In addition, in a case where both edges 32A and 32B in the width direction are warped to different degrees, the reference position 60 and the imaginary central position 61 are offset from each other in the width direction as shown in FIG. 6B in a state where the central position between both edges 32A and 32B is aligned with the reference position 60.

The offset amount calculation unit 24 calculates the offset in the width direction as an offset amount ΔL. The offset amount ΔL represents a distance by which the imaginary central position 61 is offset from the reference position 60 in the width direction.

The position correction unit 25 controls, based on the offset amount ΔL, the inclination of the axis 16A of the meandering correction roll 16 such that the imaginary central position 61 is aligned with the reference position 60. In an example shown in FIG. 6B, the inclination of the axis 16A of the meandering correction roll 16 is controlled such that the corrugated cardboard sheet 5 is moved to the left side in the drawing and the reference position 60 and the imaginary central position 61 coincide with each other.

As a result, even in the case of the corrugated cardboard sheet 5 that is warped, the position of the corrugated cardboard sheet 5 in the width direction is adjusted to an appropriate position at which the reference position 60 and the imaginary central position 61 are aligned with each other as shown in FIG. 6C.

FIGS. 7A and 7B are explanatory views relating to a change in inclination of the axis 16A of the meandering correction roll 16, and are views showing the meandering correction roll 16 together with the corrugated cardboard sheet 5 in a plan view. As represented by arrows in FIG. 7A, the axis 16A of the meandering correction roll 16 can swing around an axis extending in a height direction TD on the upper surface of the corrugated cardboard sheet 5, and the inclination of the axis 16A is changed as the axis 16A swings. The meandering correction roll 16 in FIG. 7A is in a state where the axis 16A thereof is not inclined (a state where the axis 16A coincides with a machine width direction CD). FIG. 7B is an example of a state where the axis 16A of the meandering correction roll 16 is inclined. The expression “to incline the axis 16A” means to causes the axis 16A of the meandering correction roll 16 to form an angle (an inclination angle) with respect to the machine width direction CD.

In FIG. 7A, a direction in which the axis 16A extends coincides with the width direction. In this case, the corrugated cardboard sheet 5 is transported straight to the downstream side in the transport direction MD.

Meanwhile, in a state where the axis 16A is inclined as shown in FIG. 7B, the corrugated cardboard sheet 5 is transported to the downstream side in the transport direction MD while the position of the corrugated cardboard sheet 5 in the width direction is finely adjusted in a direction along an arrow in A accordance with the inclination of the axis 16A. In this manner, meandering of the corrugated cardboard sheet 5 in the width direction is corrected.

### 3. Action and Effect

(1) In the detection device 10 of the present embodiment, the sensors 11A and 11B (the sensors 11) and the measuring unit 21 measure the plurality of measurement points P in ranges from the measurement reference points 31A and 31B to the edges 32A and 32B of the corrugated cardboard sheet 5 in the width direction by using XY coordinates with the measurement reference points 31A and 31B as origins. Then, the specifying unit 22 calculates sheet width lengths from the measurement reference points 31A and 31B to the edges 32A and 32B by adding up all of distances between measurement points that are part of the plurality of measurement points P and that are adjacent to each other and specifies positions that are separated from the measurement reference points 31A and 31B in the width direction by the sheet width lengths.

These positions can be regarded as the true edge positions 32A′ and 32B′ of the ideal corrugated cardboard sheet 5′ with no warp. Therefore, even in a case where the corrugated cardboard sheet 5 is warped, the true edge positions 32A′ and 32B′ in the width direction can be detected.

Accordingly, in the corrugating machine 40, for example, the corrugated cardboard sheet 5 can be appropriately processed or the corrugated cardboard sheet 5 can be appropriately transported based on the true edge positions 32A′ and 32B′. Specifically, since the true edge positions 32A′ and 32B′ are detected in a case where the corrugated cardboard sheet 5 is transported in a state of meandering, it is possible to transport the corrugated cardboard sheet 5 after appropriately correcting the meandering thereof in consideration of a warp.

Therefore, even in a case where a corrugated cardboard is formed from the corrugated cardboard sheet 5, the corrugated cardboard can be appropriately formed.

In addition, in the above-described related art for detecting a true plate width which is described in PTL 1, a true edge position in a state where there is no warp cannot be detected and thus offset of the position of the corrugated cardboard sheet 5 in the width direction which occurs during transportation cannot be adjusted appropriately. However, the above-described detection device 10 is more advantageous than the above-described related art since it is possible to appropriately form a corrugated cardboard from the corrugated cardboard sheet 5 with the corrugating machine 40.

(2) In the detection device 10 described above, the two sensors 11A and 11B are disposed adjacent to each other in the width direction and thus it is possible to specify one true edge position 32A′ by measuring the measurement range 30A including the one edge 32A with one sensor 11A and to specify the other true edge position 32B′ by measuring the measurement range 30B including the other edge 32B with the other sensor 11B. Therefore, the true edge positions 32A′ and 32B′ can be accurately detected for each of both edges 32A and 32B of the corrugated cardboard sheet 5.

In addition, in a case where the positions of both edges 32A and 32B are to be specified by one sensor 11, it is necessary to devise disposition such that both edges 32A and 32B are included in the measurement range 30 of the one sensor 11 or to use a sensor of which a laser beam irradiation range (the measurement range) is wide. However, since the sensors 11A and 11B respectively dedicated for the edges 32A and 32B are provided, it is possible to increase the degree of freedom of disposition of the measurement ranges 30A and 30B of the sensors 11A and 11B.

(3) In the sheet position adjustment device 50, the offset amount calculation unit 24 calculates, by using the true edge positions 32A′ and 32B′ specified by the detection device 10, an offset amount indicating a degree to which the corrugated cardboard sheet 5 is offset in the width direction from a position at which the corrugated cardboard sheet 5 is supposed to be transported. The position correction unit 25 adjusts the position of the corrugated cardboard sheet 5 in the width direction based on the calculated offset amount in addition to the reference position 60 at the time of transportation of the corrugated cardboard sheet 5 through the transport path 15. Therefore, even the corrugated cardboard sheet 5 that is warped can be appropriately transported in accordance with the reference position 60.

(4) The above-described offset amount is calculated through comparison between the imaginary central position 61 based on the true edge positions 32A′ and 32B′ and the reference position 60 based on the central position of the bottom liner 4D in the width direction, the bottom liner 4D being bonded to the single-faced web 5. Therefore, in a case where the position of the single-faced web 5 in the width direction is adjusted by using the imaginary central position 61, the single-faced web 5 can be appropriately transported with respect to the bottom liner 4D and offset occurring when the single-faced web 5 is bonded to the bottom liner 4D can be suppressed.

(5) Since the above-described detection device 10 is provided, even in a case where the corrugated cardboard sheet 5 is warped in the corrugating machine 40, the true edge positions 32A′ and 32B′ in a case where the corrugated cardboard sheet 5 is flattened such that there is no warp can be detected. In addition, it is possible to adjust, based on the true edge positions 32A′ and 32B′, the position of the corrugated cardboard sheet 5 in the width direction by using the sheet position adjustment device 50. Therefore, the corrugated cardboard sheet 5 can be appropriately transported. Accordingly, the corrugating machine 40 can properly process the corrugated cardboard sheet 5.

### 4. Others

The above-described embodiment is merely an example. Each configuration of the above-described embodiment can be selected as necessary, or may be appropriately combined with various configurations included in the known technique.

In the sheet position adjustment device 50 of the above-described embodiment, the central position of the bottom liner 4D in the width direction is the reference position 60. However, one edge position of the bottom liner 4D in the width direction may also serve as a reference position. In this case, the position detection unit 23 specifies the one edge position of the bottom liner 4D (a liner sheet) in the width direction based on data of an image captured by the camera 17 and transmits the specified one edge position to the offset amount calculation unit 24 as the reference position. The offset amount calculation unit 24 calculates an offset amount by comparing a true edge position transmitted from the specifying unit 22 and the reference position transmitted from the position detection unit 23.

FIGS. 8A to 8C are explanatory views relating to position adjustment in the width direction performed in a case where an edge position of the bottom liner 4D in the width direction is a reference position 70 and are views corresponding to FIGS. 6A to 6C. Note that only in FIG. 8A, a cross-sectional view along the width direction is added to show the corrugated cardboard sheet 5 being warped. One-dot chain lines in the drawings are lines obtained by extending the reference position 70 in the transport direction MD for the sake of convenience of description. As with FIGS. 6A to 6C, the corrugated cardboard sheet 5 shown in FIGS. 8A to 8C is also warped at regions including both edges 32A and 32B in the width direction.

FIG. 8A shows a state where the position of the other edge 32B is aligned with the reference position 70 represented by the one-dot chain line. Broken lines in FIG. 8B are lines obtained by extending the specified true edge positions 32A′ and 32B′ in the transport direction MD and a two-dot chain line in FIG. 8B is a line obtained by extending the other true edge position 32B′ in the transport direction MD, the true edge position 32B′ being used for position adjustment.

In the sheet position adjustment device 50 of the present modification example, the offset amount calculation unit 24 calculates, as the offset amount ΔL′, offset of the other true edge position 32B′ with respect to the reference position 70 in the width direction.

The position correction unit 25 of the present modification example controls, based on the offset amount ΔL′, the inclination of the axis 16A of the meandering correction roll 16 such that the other true edge position 32B′ is aligned with the reference position 70. In an example shown in FIG. 8B, the inclination of the axis 16A of the meandering correction roll 16 is controlled such that the corrugated cardboard sheet 5 is moved to the left side in the drawing and the reference position 70 and the other true edge position 32B′ coincide with each other.

As a result, even in the case of the corrugated cardboard sheet 5 that is warped, the position of the corrugated cardboard sheet 5 in the width direction is adjusted to an appropriate position at which the reference position 70 and the true edge position 32B′ are aligned with each other as shown in FIG. 8C. With the sheet position adjustment device 50 according to such a modification example as well, the same action and effect as the above-described embodiment can be achieved.

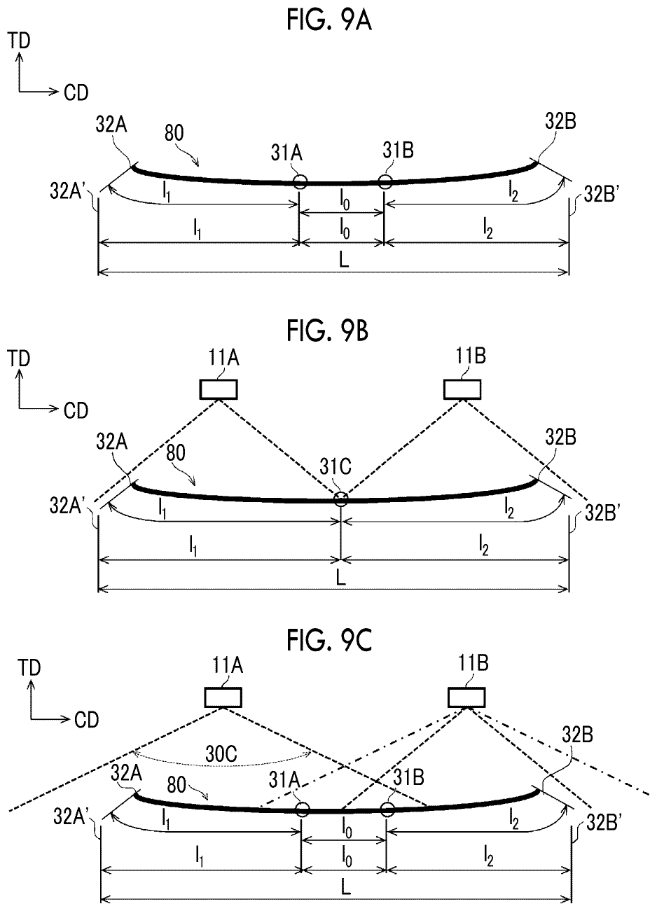

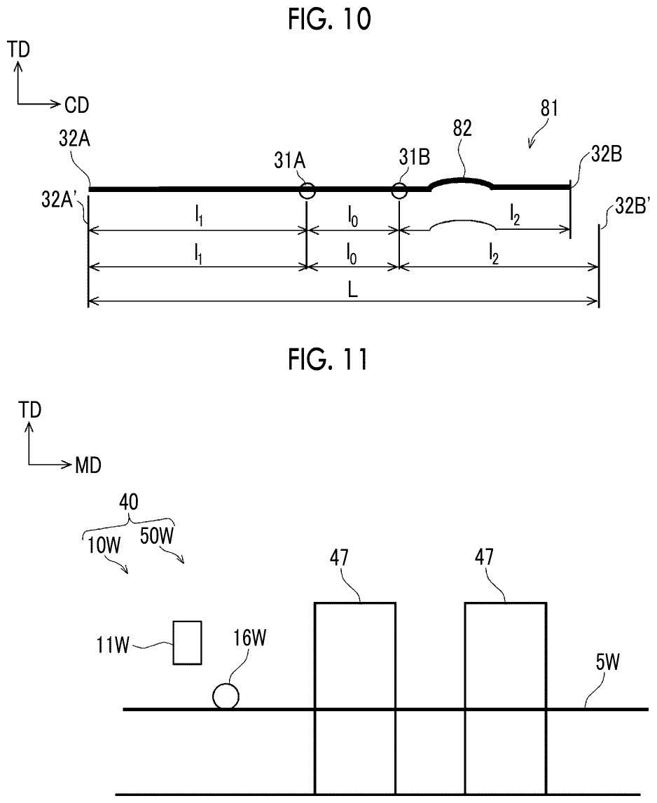

In addition, a place where the corrugated cardboard sheet 5 is warped is not limited to the regions including both edges 32A and 32B in the width direction. FIGS. 9A to 9C and FIG. 10 show modification examples of a warp and are the same as FIG. 4 except for a shape into which a corrugated cardboard sheet is warped.

In FIG. 9A, a shape in which a corrugated cardboard sheet 80 is warped throughout a region including both edges 32A and 32B in the width direction and a central portion in the width direction is shown as an example. In addition, in FIG. 10, a shape in which a partial region 82 positioned between the other edge 32B of a corrugated cardboard sheet 81 and a central portion in the width direction is protrude upward higher than the other portion is shown as an example.

For any of the corrugated cardboard sheet 80 of FIG. 9A and the corrugated cardboard sheet 81 of FIG. 10, the specifying unit 22 can specify the true edge positions 32A′ and 32B′ by calculating the first sheet width length l₁, the second sheet width length 12, and the central sheet width length l₀ with the same method as in the above-described embodiment. In this manner, according to the above-described detection device 10, true edge positions can be specified and detected regardless of a shape into which the corrugated cardboard sheet 5 is warped.

FIG. 9B is the same as FIG. 9A except that one measurement reference point 31C is set with respect to the two sensors 11A and 11B. In this case, one sensor 11A and the measuring unit 21 measure a plurality of the measurement points P in a range from the measurement reference point 31C to the one edge 32A and the other sensor 11B and the measuring unit 21 measure a plurality of the measurement points P in a range from the measurement reference point 31C to the other edge 32B.

The specifying unit 22 can specify the total sheet width length L of the ideal corrugated cardboard sheet 5′ or the true edge positions 32A′ and 32B′ by calculating the first sheet width length 11 from the measurement reference point 31C to the one edge 32A and the second sheet width length 12 from the measurement reference point 31C to the other edge 32B.

FIG. 9C is the same as FIG. 9A except that a measurement range 30C of the sensor 11A (one of the two sensors 11A and 11B) is expanded such that both of the measurement reference points 31A and 31B are brought within the measurement range 30C.

In this case, one sensor 11A and the measuring unit 21 measure a plurality of the measurement points P in a range from the measurement reference point 31A to the one edge 32A and a plurality of the measurement points P between the measurement reference point 31A and the measurement reference point 31B and the other sensor 11B and the measuring unit 21 measure a plurality of the measurement points P in a range from the measurement reference point 31B to the other edge 32B.

The specifying unit 22 can specify the total sheet width length L of the ideal corrugated cardboard sheet 5′ or the true edge positions 32A′ and 32B′ by calculating the first sheet width length 11 and the central sheet width length l₀ by means of the plurality of measurement points P measured by the one sensor 11A and the measuring unit 21 and calculating the second sheet width length 12 by means of the plurality of measurement points P measured by the other sensor 11B and the measuring unit 21.

As a modification example of FIG. 9C, the measurement ranges of both of the two sensors 11A and 11B may be expanded such that both of the measurement reference points 31A and 31B are brought within the measurement ranges. In FIG. 9C, one-dot chain lines represent the measurement range of the sensor 11B which has been expanded such that both of the measurement reference points 31A and 31B are brought within the measurement range.

In this case, one sensor 11A and the measuring unit 21 measure a plurality of the measurement points P in a range from the measurement reference point 31A to the one edge 32A and a plurality of the measurement points P between the measurement reference point 31A and the measurement reference point 31B and the other sensor 11B and the measuring unit 21 measure a plurality of the measurement points P in a range from the measurement reference point 31B to the other edge 32B and a plurality of the measurement points P between the measurement reference point 31A and the measurement reference point 31B.

The specifying unit 22 calculates the first sheet width length 11 and the central sheet width length l₀ by means of the plurality of measurement points P measured by the one sensor 11A and the measuring unit 21 and calculates the second sheet width length 12 and the central sheet width length l₀ by means of the plurality of measurement points P measured by the other sensor 11B and the measuring unit 21. Examples of a method of specifying one of the two central sheet width lengths l₀ calculated in duplicate include a method of adopting the average of the two lengths, a method of adopting the larger length of the two lengths, and a method of adopting the smaller length of the two lengths. Which method is used may be determined as appropriate.

In addition, an arithmetic equation used to calculate a sheet width length in the specifying unit 22 is not limited to Equation 1 described above and an arithmetic equation known as an equation for obtaining the length of a curve can also be used.

For example, it will be assumed that a curve connecting the measurement reference point 31A (31B) and the edge 32A (32B) close to the measurement reference point 31A (31B) is represented by y=f (x), the measurement reference point 31A (31B) is x=a, and the edge 32A (32B) is x=b. A length L of the curve represented by y=f (x) is obtained by Equation 2 as follows.

$$[ Equation 2 ]$$

$$L = {\int }_{a}^{b} \sqrt{1 + {( {y}^{′} )}^{2}} dx \qquad Equation 2$$

In addition, assuming that the curve connecting the measurement reference point 31A (31B) and the edge 32A (32B) is a curve r=1+cos θ represented by polar coordinates, the length L of the curve connecting the measurement reference point 31A (31B) and the edge 32A (32B) is obtained by Equation 3 as follows.

$$[ Equation 3 ]$$

$$L = {\int }_{{θ}_{1}}^{{θ}_{1}} \sqrt{{r}_{2} + {( \frac{dr}{d θ} )}^{2}} d θ \qquad Equation 3$$

In the above-described embodiment, a case where a plurality of the measurement points P in each of the measurement ranges 30A and 30B are set in a linear shape in the width direction orthogonal to the transport direction of the corrugated cardboard sheet 5 has been used as an example. However, the way in which the plurality of measurement points P are set is not limited thereto.

For example, a straight line connecting the plurality of measurement points P in each of the measurement ranges 30A and 30B may be a straight line extending in the width direction while being inclined with respect to the transport direction of the corrugated cardboard sheet 5 at a predetermined angle. Alternatively, a straight line connecting the plurality of measurement points P in the measurement range 30A and a straight line connecting the plurality of measurement points P in the measurement range B may extend in the width direction while being inclined with respect to the transport direction of the corrugated cardboard sheet 5 at different angles. In other words, the plurality of the measurement points P in the measurement ranges 30A and 30B may not be set in a linear shape.

In addition, the configuration of the detection device 10 is not limited to a configuration including the two sensors 11A and 11B and the detection device 10 may have a configuration including three or more sensors. In this case, the sensor 11 positioned at an edge of the corrugated cardboard sheet 5 in the width direction and the measuring unit 21 measure a plurality of the measurement points P within a range from any measurement reference point to the edge of the corrugated cardboard sheet 5 in the width direction. In addition, the sensor 11 positioned close to the center of the corrugated cardboard sheet 5 in the width direction and the measuring unit 21 measure a plurality of the measurement points P between any measurement reference points.

In the specifying unit 22, a sheet width length is calculated by using the plurality of measurement points P measured by the sensor 11 positioned at the edge of the corrugated cardboard sheet in the width direction and the measuring unit 21. In addition, the sheet width length is calculated by using the plurality of measurement points P measured by the sensor 11 positioned close to the center of the corrugated cardboard sheet 5 in the width direction and the measuring unit 21. In this manner, the total sheet width length L of the ideal corrugated cardboard sheet or a true edge position can be specified.

According to a configuration in which three or more (a plurality of) sensors 11 are provided in the width direction, more accurate measurement can be performed in comparison with a configuration in which two or less sensors 11 are provided. Therefore, the true edge position can be obtained with high accuracy.

In addition, the configuration of the detection device 10 is not limited to a configuration including the two sensors 11A and 11B and the detection device 10 may have a configuration including only one sensor 11. In this case, the detection device 10 may be configured to specify any one edge position of the corrugated cardboard sheet 5 in the width direction with the one sensor 11 or may be configured to specify both of edge positions of the corrugated cardboard sheet 5 in the width direction with the one sensor 11.

The reference position at the time of transportation of the single-faced web 5 in the transport path 15 is not limited to the position of the bottom liner 4D in the width direction and may be a position based on the machine width direction CD of the transport path 15.

A corrugated cardboard sheet which is the target of the above-described detection device 10 and the sheet position adjustment device 50 is not limited to a single-faced web and may be any corrugated cardboard sheet such as a liner sheet, a single-wall corrugated cardboard, and a double-faced double-wall corrugated cardboard sheet.

FIG. 11 is an explanatory view of a detection device 10W for specifying a true edge position of the single-wall corrugated cardboard 5W in the width direction and a sheet position adjustment device 50W. The corrugating machine 40 in FIG. 2 is equipped with the detection device 10W and the sheet position adjustment device 50W in FIG. 11.

In the detection device 10W of FIG. 11, a sensor 11W is provided downstream of the double facer 46 (refer to FIG. 2) and upstream of the slitter scorer 47 and is the same as the sensor 11 in FIG. 1 except that the sensor 11W detects an edge position of the single-wall corrugated cardboard 5W in the width direction. Functional elements relating to the detection device 10W are the same as those of the measuring unit 21 and the specifying unit 22 described above with reference to FIG. 1.

In the sheet position adjustment device 50W of FIG. 11, a meandering correction roll 16W is provided downstream of the double facer 46 and upstream of the slitter scorer 47 and is the same as the meandering correction roll 16 in FIG. 1 except that the meandering correction roll 16w adjusts the position of the single-wall corrugated cardboard 5W in the width direction.

In the sheet position adjustment device 50W, the position of the single-wall corrugated cardboard 5W in the width direction is adjusted during transportation to match a reference position at the time of transportation of the single-wall corrugated cardboard 5W.

For example, there may be a case where a central position in the machine width direction CD of the corrugating machine 40 is used as a reference position in the sheet position adjustment device 50W. Specifically, the central position in the machine width direction CD is a central position in the machine width direction CD of a transport path for transportation of the single-wall corrugated cardboard 5W. This central position is set in advance as a position corresponding to the central position of the single-wall corrugated cardboard in the width direction in a state where an ideal single-wall corrugated cardboard with no warp is transported without meandering.

The offset amount calculation unit 24 (refer to FIG. 1) and the position correction unit 25 (refer to FIG. 1) are the same as those described above except that the reference position is the central position in the machine width direction CD of the corrugating machine 40. Therefore, the inclination of the axis 16A of the meandering correction roll 16W is controlled based on an offset amount obtained by using a true edge position. Therefore, even in the case of the single-wall corrugated cardboard 5W that is warped, meandering during transportation can be corrected and the single-wall corrugated cardboard 5W can be transported appropriately.

As another example of the reference position in the sheet position adjustment device 50W of FIG. 11, one edge position in the machine width direction CD of the corrugating machine 40 can be used.

Specifically, the one edge position in the machine width direction CD is one edge position of any one of both edges in the machine width direction CD of the transport path for transportation of the single-wall corrugated cardboard 5W. Regarding the edge position, the edge position of any one of both edges of the single-wall corrugated cardboard in a state where an ideal single-wall corrugated cardboard with no warp is transported without meandering is determined in advance as the reference position. The offset amount calculation unit 24 (refer to FIG. 1) and the position correction unit 25 (refer to FIG. 1) are the same as those described above except that the reference position is one edge position in the machine width direction CD of the corrugating machine 40. Therefore, the inclination of the axis 16A of the meandering correction roll 16W is controlled based on an offset amount obtained by using a true edge position. Therefore, even in the case of the single-wall corrugated cardboard 5W that is warped, meandering during transportation can be corrected and the single-wall corrugated cardboard 5W can be transported appropriately.

Note that in the above-described embodiment shown in FIG. 11, a method of correcting meandering during transportation by controlling, based on an offset amount obtained by using a true edge position of the single-wall corrugated cardboard 5W, the inclination of the axis 16A of the meandering correction roll 16w has been used as an example of a meandering correction method. However, the meandering correction method is not limited thereto. For example, the position of a processing device (not shown) in the width direction may be adjusted based on an offset amount obtained by using a true edge position of the single-wall corrugated cardboard 5W, the processing device being provided at the slitter scorer 47. Here, the processing device is a device of which the position in the width direction can be adjusted with respect to the single-wall corrugated cardboard 5W. Specific examples of the processing device include a slitter knife for cutting the single-wall corrugated cardboard 5W along the transport direction, a creasing roll for forming a creasing line with respect to the single-wall corrugated cardboard 5W, a cut tape device for annexing cut tape with respect to the single-wall corrugated cardboard 5W, and a perforation blade for forming perforations with respect to the single-wall corrugated cardboard 5W. In a case where the position of the processing device in the width direction is adjusted, processing can be performed with respect to an appropriate position of the single-wall corrugated cardboard 5W in the width direction.

### REFERENCE SIGNS LIST

4A: paper roll for top liner
4B: paper roll for medium
4C: paper roll for bottom liner
4D: bottom liner (liner sheet)
5: single-faced web (corrugated cardboard sheet)
5W: single-wall corrugated cardboard
5X: corrugated cardboard
10, 10W: detection device
11, 11W: sensor (measurement means)
11A: first sensor (first measurement means)
11B: second sensor (second measurement means)
15: transport path
16, 16W: meandering correction roll (correction means)
16A: axis
17: camera
20: control device
21: measuring unit (measurement means)
22: specifying unit (specifying means)
23: position detection unit
24: offset amount calculation unit (calculation means)
25: position correction unit (correction means)
30, 30A, 30B: measurement range
31A: first measurement reference point
31B: second measurement reference point
32A: one edge (one edge in width direction)
32B: other edge (other edge in width direction)
32A′: one true edge position
32B′: other true edge position
40: corrugating machine
41A, 41B, 41C: mill roll stand
42: single facer
43: bridge
44: preheater
45: glue machine
46: double facer
47: slitter scorer
48: cutoff
49: transport path
50, 50W: sheet position adjustment device
60: reference position
61: imaginary central position
70: reference position
80, 81: corrugated cardboard sheet
82: protrusion
ΔL, ΔL′: offset amount
CD: machine width direction
MD: transport direction
TD: height direction (vertical direction)

1. A detection device that detects a position of an edge of a band-shaped corrugated cardboard sheet in a width direction while the corrugated cardboard sheet is being transported, the device comprising:
measurement means for measuring, within a measurement range including a predetermined measurement reference point of the corrugated cardboard sheet in the width direction and the edge on at least one side in the width direction, positions of a plurality of measurement points in a linear shape in the width direction; and
specifying means for specifying, based on the plurality of measurement points measured by the measurement means, a true edge position in the width direction in a state where the corrugated cardboard sheet is not warped,
wherein the specifying means calculates each of distances between the measurement points adjacent to each other, adds up all the distances to calculate a sheet width length from the measurement reference point to the edge, and specifies, as the true edge position, a position that is separated from the measurement reference point in the width direction by the sheet width length.

2. The detection device according to claim 1,
wherein a plurality of the measurement means are provided in the width direction.

3. The detection device according to claim 1,
wherein the measurement means includes first measurement means for specifying the edge on the one side in the width direction and second measurement means for specifying an edge of the corrugated cardboard sheet that is on the other side in the width direction, the second measurement means being disposed on the other side in the width direction to be adjacent to the first measurement means.

4. A sheet position adjustment device comprising:
the detection device according to claim 1;
calculation means for calculating, based on the true edge position specified by the detection device and a reference position at a time of transportation of a band-shaped corrugated cardboard sheet, an offset amount of a position of the corrugated cardboard sheet in a width direction; and
correction means for correcting, based on the offset amount calculated by the calculation means, the position of the corrugated cardboard sheet in the width direction.

5. The sheet position adjustment device according to claim 4,
wherein the corrugated cardboard sheet is a single-faced web,
the reference position is a central position of a liner sheet in the width direction, the liner sheet being bonded to the single-faced web, and
the calculation means specifies an imaginary central position of the single-faced web in the width direction based on the true edge position and compares the specified imaginary central position and the reference position with each other to calculate the offset amount.

6. The sheet position adjustment device according to claim 4,
wherein the corrugated cardboard sheet is a single-faced web,
the reference position is an edge position of a liner sheet that is on one side in the width direction, the liner sheet being bonded to the single-faced web, and
the calculation means compares the true edge position on the one side in a width direction of the single-faced web and the reference position with each other to calculate the offset amount.

7. The sheet position adjustment device according to claim 4,
wherein the corrugated cardboard sheet is a single-wall corrugated cardboard,
the reference position is a central position in a machine width direction of a corrugating machine manufacturing the single-wall corrugated cardboard, and
the calculation means specifies an imaginary central position of the single-wall corrugated cardboard in the width direction based on the true edge position and compares the specified imaginary central position and the reference position with each other to calculate the offset amount.

8. The sheet position adjustment device according to claim 4,
wherein the corrugated cardboard sheet is a single-wall corrugated cardboard,
the reference position is an edge position on one side in a machine width direction of a corrugating machine manufacturing the single-wall corrugated cardboard, and
the calculation means compares the true edge position on the one side in a width direction of the single-wall corrugated cardboard and the reference position with each other to calculate the offset amount.

9. A corrugating machine comprising:
the sheet position adjustment device according to claim 4.
